(19) United States
(12) Patent Application Publication
(10) Pub. No.: US 2004/0252490 A1
(43) Pub. Date: Dec. 16, 2004

(54) Trash storage apparatus

(76) Inventor: Tsong-Yow Lin, Taichung Hsien (TW)

Correspondence Address: Alan D. Kamrath, Rider Bennett, LLP, Suite 2000, 333 South Seventh Street, Minneapolis, MN, 55402, US

(21) Appl. No.: 10/459,953

(22) Filed: Jun. 12, 2003

(51) Int. Cl. F21V 33/00; F21V 9/16

(52) U.S. Cl. 362/154; 362/84

(57) ABSTRACT

A trash storage apparatus includes a can, an illuminating element and a driver. The can is used for receiving garbage. The illuminating element is mounted on the can. The driver is used for driving the illuminating element to shine in the dark. The trash storage apparatus may include a lid for covering the can and a pedal connected with the lid. The illuminating element is attached to the pedal.

### FIELD OF INVENTION

The present invention relates to a trash storage apparatus.

### BACKGROUND OF INVENTION

Taiwanese Patent publication No. 354560 discloses a trash storage apparatus including a can 1 and a lighting set 2. The lighting set 2 is mounted on the can 1. The lighting set 2 can cast light onto the can 1 for illuminative and aesthetic purposes so that the can 1 is visible in the night. Hence, a user needs no time to search for the can 1. However, the lighting set 2 includes a bulb 24 that provides strong light and much heat. Thus, it is only suitable for outdoor use. The lighting set 2 is connected with an external power source by means of a wire 14. Since there is no switch, a user must pull the wire 14 from the external power source in order to turn off the lighting set 2. A user however often forgets to pull the wire 14 from the external power source so that the lighting set 2 continues to shine in the daytime. Thus, the bulb 24 wastes much energy.

The present invention is therefore intended to obviate or at least alleviate the problems encountered in prior art.

### SUMMARY OF INVENTION

It is the primary objective of the present invention to provide an energy-economic trash storage apparatus.

A trash storage apparatus includes a can, an illuminating element and a driver. The can is used for receiving garbage. The illuminating element is mounted on the can. The driver is used for driving the illuminating element to shine in the dark.

Other objects, advantages, and novel features of the invention will become more apparent from the following detailed description when taken in conjunction with the attached drawings.

### BRIEF DESCRIPTION OF DRAWING

The present invention will be described through detailed illustration of embodiments referring to the attached drawings.

FIG. 1 is a perspective view of a trash storage apparatus according to a first embodiment of the present invention.

FIG. 2 is an exploded view of the trash storage apparatus shown in FIG. 1.

FIG. 3 is similar to FIG. 1 but showing the trash storage apparatus in the operative condition.

FIG. 4 is a perspective view of the trash storage apparatus according to a second embodiment of the present invention.

FIG. 5 is an exploded view of the trash storage apparatus shown in FIG. 4.

FIG. 6 is a top view of the trash storage apparatus according to a third embodiment of the present invention.

FIG. 7 is a side view of the trash storage apparatus shown in FIG. 6.

FIG. 8 is a perspective view of the trash storage apparatus according to a fourth embodiment of the present invention.

FIG. 9 is a perspective view of the trash storage apparatus according to a fifth embodiment of the present invention.

### DETAILED DESCRIPTION OF PREFERRED EMBODIMENT

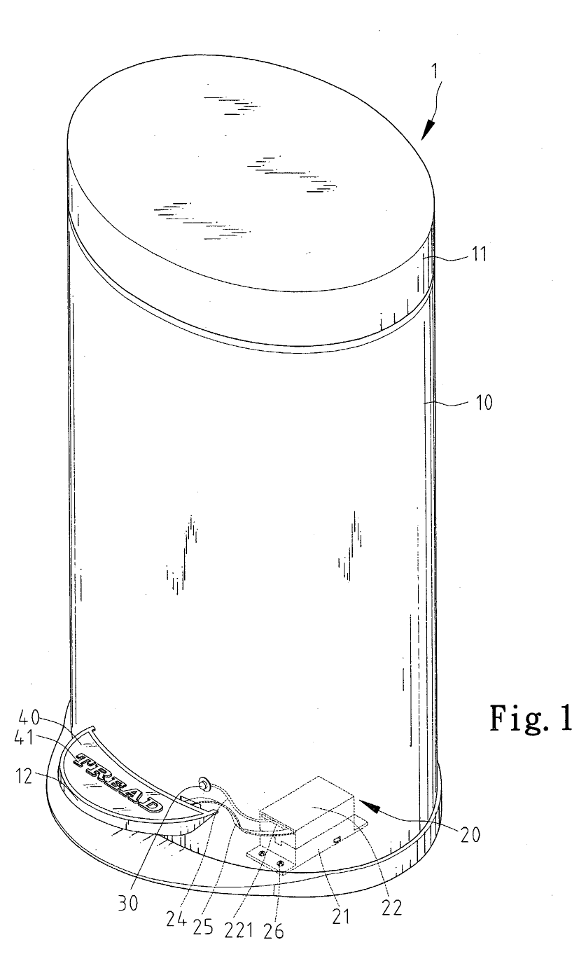

Referring to FIG. 1˜3, according to a first embodiment of the present invention, a trash storage apparatus includes a can 10, a lid 11, a sensor 30, a driver 20, two wires 24 and 25, a pedal 12 and a luminescent element 40.

Referring to FIG. 1, the can 10 is used for receiving garbage. The lid 11 is mounted on the can 10. The sensor 30 is mounted on the can 10. The pedal 12 is connected with the lid 11. The illuminating element 40 is attached to the pedal 12. The illuminating element 40 is a luminescent element. The sensor 30 is connected with the driver 20 via a wire 24. The luminescent element 40 is connected with the driver 20 via a wire 25. The driver 20 is used for driving the luminescent element 40 to shine according to a signal transmitted from the sensor 30.

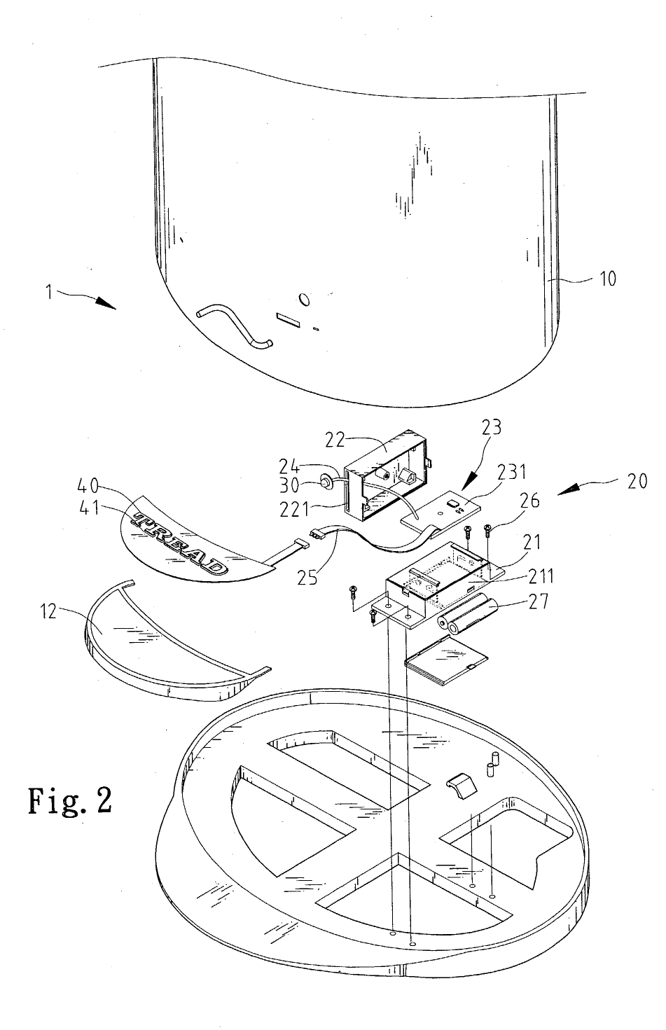

Referring to FIG. 2, the driver 20 includes a cover 22 and a box 21. The box 21 includes a control device 23. The box 21 is secured to the can 10 by means of bolts. A space 211 is defined in the box 21 for receiving a battery 27 that is connected with the control device 23. A slot 221 is defined in the cover 22. The wire 24 extends through the slot 221. The wire 25 extends through the slot 221. The control device 23 includes a circuit board 231. The circuit board 231 includes a central processing unit, a power source control unit and a signal-processing unit (not shown). How the circuit board 231 receives or transmits signal is conventional. The sensor 30 may be an optical sensor. As brightness in the environment is below a criterion, the optical sensor transmits a signal to the control device 23 for driving the luminescent element 40 to shine. On the contrary, as the brightness in the environment is above the criterion, the control device 23 turns off the luminescent element 40. The luminescent element 40 is shaped according to the pedal 12. “Tread” may be printed or molded on the luminescent element 40. A luminescent element 41 may be shaped as “Tread.” The central processing unit controls the luminescent elements 40 and 41 to shine by turns or simultaneously.

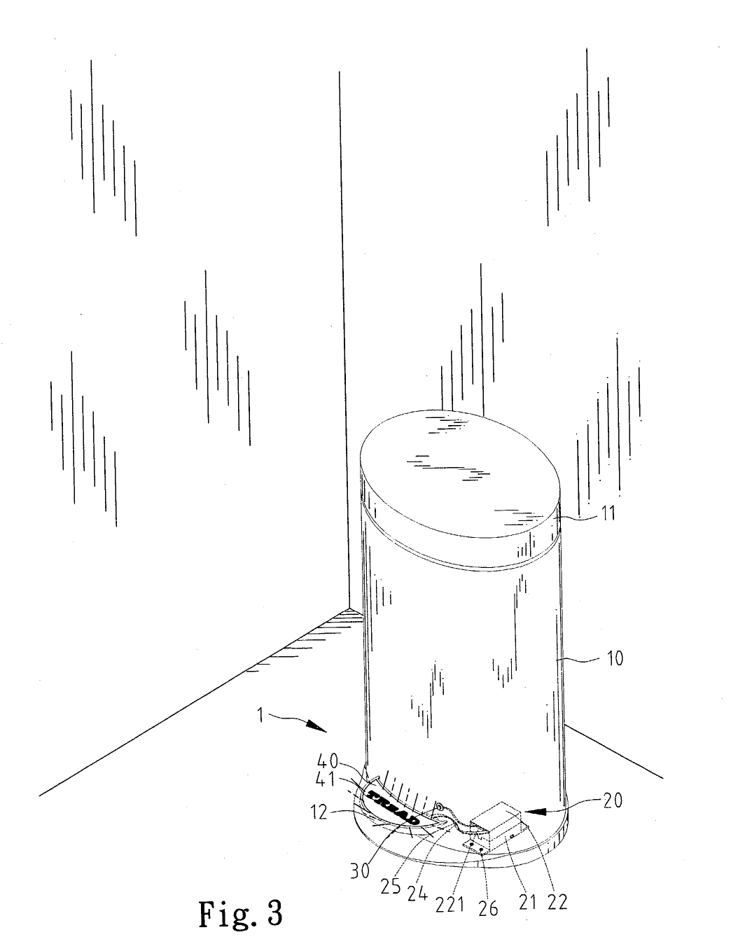

Referring to FIG. 3, when the brightness is below the criterion, the sensor 30 transmits the signal to the control device 23. The signal is processed by means of the control device 23 for driving the luminescent element 40 to shine so that the trash storage apparatus is visible.

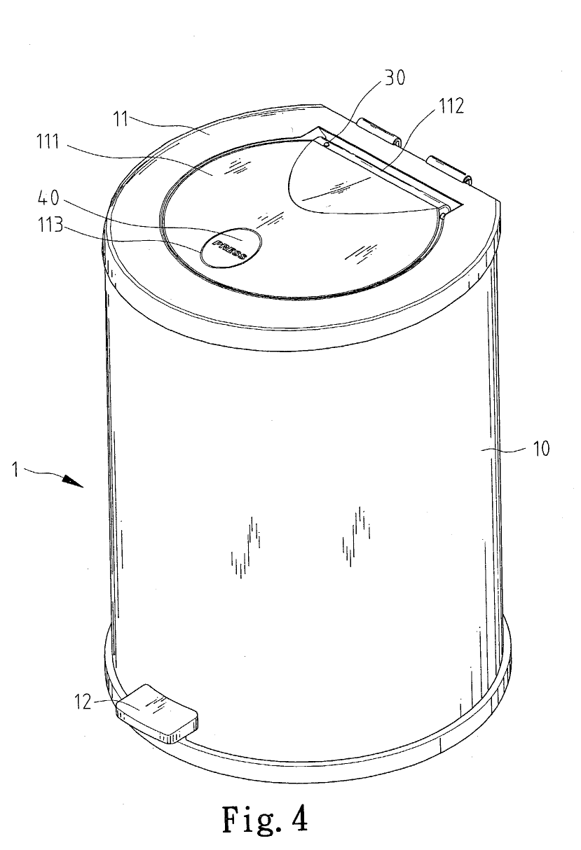

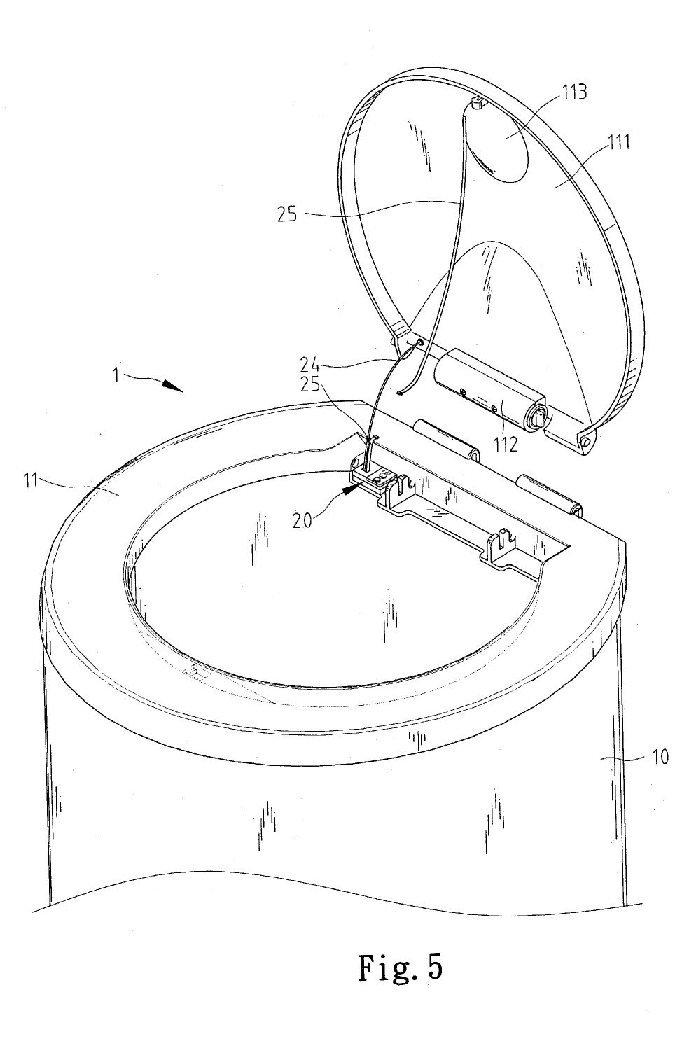

FIGS. 4 and 5 show a second embodiment according to the present invention. The trash storage apparatus includes an annular lid 11 and a lid 111 located within the annular lid 11. An end of the lid 111 is pivotally connected with the annular lid 11. The luminescent element 40 is mounted on another end of the lid 111. Opening and closing of the annular lid 11 and the lid 111 are conventional and will not be described in detail. The driver 20 is mounted on the annular lid 11. The sensor 30 is mounted on the lid 111. The sensor 30 is connected with the driver 20 through the wire 24. The luminescent element 40 is connected with the driver 20 through the wire 25. Thus, when the brightness in the environment is below the criterion, the driver 20 drives the luminescent element 40 to shine.

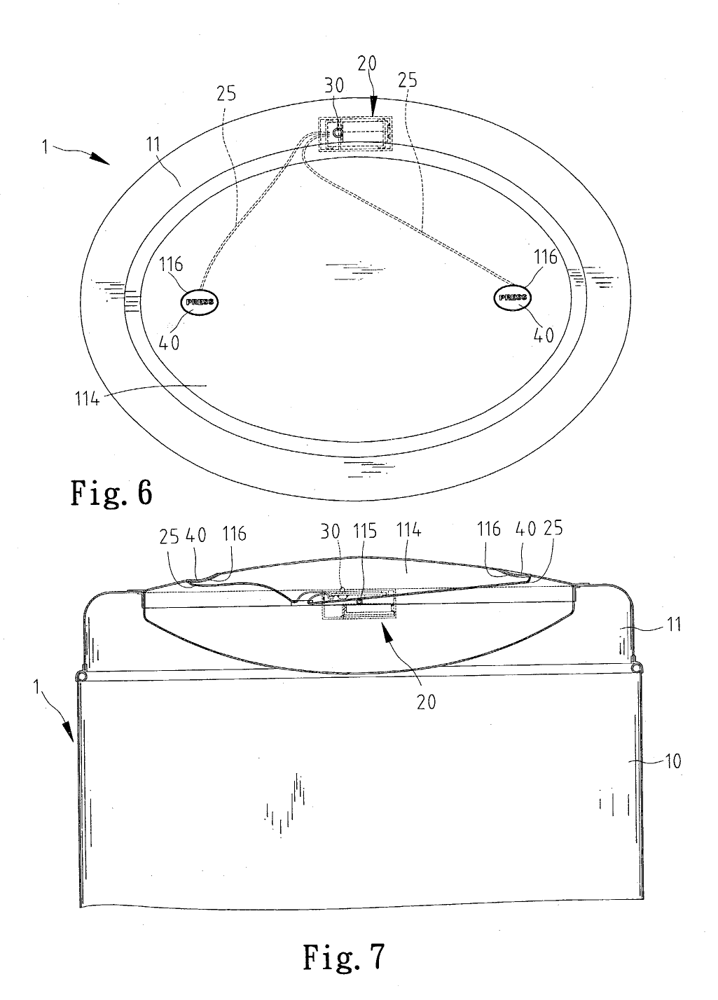

FIGS. 6 and 7 show a third embodiment according to the present invention. The trash storage apparatus includes an annular lid 11 and a lid 114 located within the annular lid 11. An end of the lid 114 is pivotally connected with the annular lid 11. Two luminescent elements 40 are mounted on the lid 114. The driver 20 and the sensor 30 are mounted on the lid 11. The third embodiment is otherwise identical to the second embodiment.

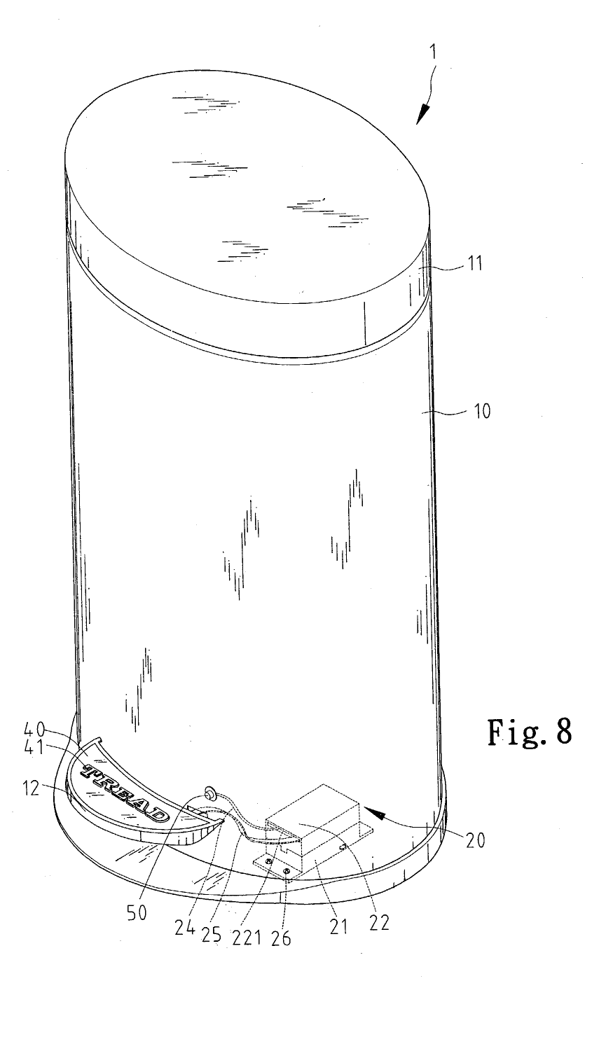

FIG. 8 shows a fourth embodiment according to the present invention. The sensor 30 of the first embodiment is replaced with a switch 50 in the fourth embodiment. Thus, when the brightness in the environment is insufficient, the user uses the switch 50 to turn on the illuminating element 40 to shine. Moreover, the circuit board 231 includes a timer (not shown). That is, times to turn on and off the luminescent element 40 can be set so that the luminescent element 40 illuminates for a set period of time.

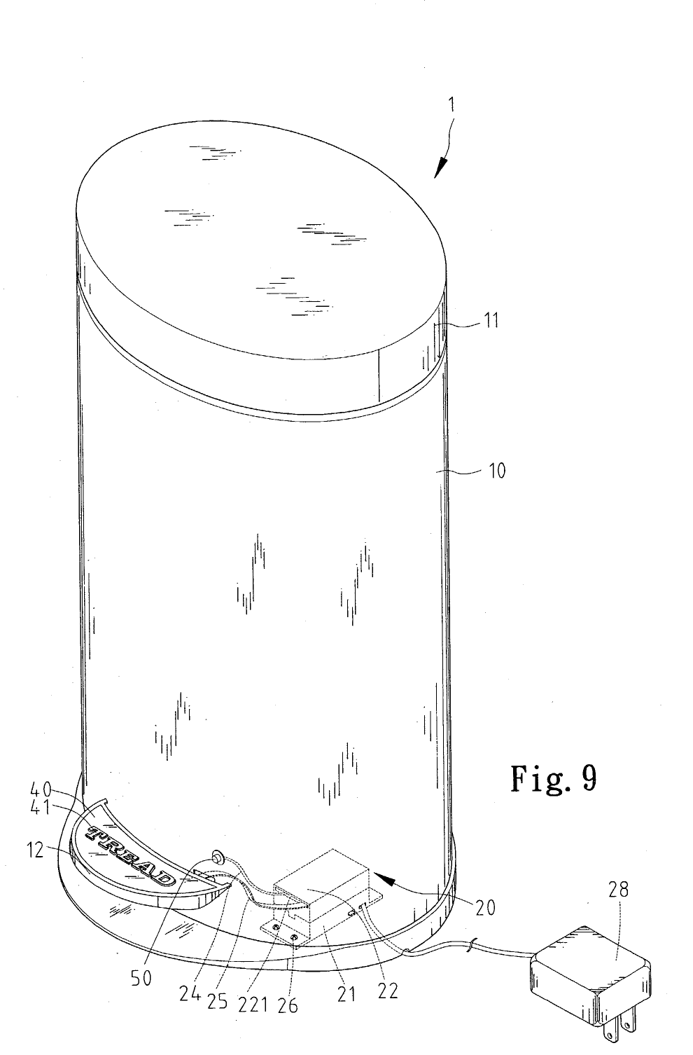

FIG. 9 shows a fifth embodiment according to the present invention. The driver 20 is provided with a transformer 28. The driver 20 can be connected with an external power source through the transformer 28.

The present invention has been described through detailed illustration of five embodiments. Those skilled in the art can derive variations from the embodiments without departing from the scope of the present invention. Therefore, the embodiments shall not limit the scope of the present invention defined in the claims.

What is claimed is:

1. A trash storage apparatus including a can for receiving garbage, an illuminating element mounted on the can and a driver for driving the illuminating element to shine in the dark.

2. The trash storage apparatus according to claim 1 including a lid for covering the can.

3. The trash storage apparatus according to claim 2 including a pedal connected with the lid, wherein the illuminating element is attached to the pedal.

4. The trash storage apparatus according to claim 1 including a wire connected between the illuminating element and the driver.

5. The trash storage apparatus according to claim 1 wherein the driver includes a box, a cover for closing the box and at least one battery put in the box for powering the driver.

6. The trash storage apparatus according to claim 1 wherein the driver includes a transformer for connection with an alternating current power source.

7. The trash storage apparatus according to claim 1 wherein the driver drives the illuminating element to shine continuously.

8. The trash storage apparatus according to claim 1 wherein the driver drives the illuminating element to flash.

9. The trash storage apparatus according to claim 1 including another illuminating elements.

10. The trash storage apparatus according to claim 9 wherein the driver drives the illuminating elements to shine synchronously.

11. The trash storage apparatus according to claim 9 wherein the driver drives the illuminating elements to shine by turns.

12. The trash storage apparatus according to claim 1 wherein the illuminating element is a luminescent element.

13. The trash storage apparatus according to claim 1 including a sensor for sending a signal to the driver that in turn drives the illuminating element to shine.

14. The trash storage apparatus according to claim 13 including a wire for connecting the sensor with the driver.

15. The trash storage apparatus according to claim 13 wherein the driver includes a circuit board including a central processing unit for processing and sending the signal.

16. A trash storage apparatus including a can for receiving garbage, an illuminating element mounted on the can, a driver for driving the illuminating element to shine and a switch connected with the driver.

17. The trash storage apparatus according to claim 16 including a wire for connecting the switch with the driver.

18. A trash storage apparatus including a can for receiving garbage, a luminescent element mounted on the can and a driver for driving the luminescent element to shine.
